(19) United States
(12) Patent Application Publication
(10) Pub. No.: US 2012/0153701 A1
(43) Pub. Date: Jun. 21, 2012

(54) VENTILATIVE VEHICLE SEAT BACK

(76) Inventor: Chen-Chang Lin, Taichung County (TW)

(21) Appl. No.: 12/975,111

(22) Filed: Dec. 21, 2010

(51) Int. Cl. B60N 2/56

(52) U.S. Cl. 297/452.46

(57) ABSTRACT

A ventilative vehicle seat back of the present invention includes a main body, at least one air channel, plural air holes, and a deflector. The main body has a reclining surface, two side surfaces and a first connecting portion. One of the side surfaces is formed with at least one inlet, and the first connecting portion is located at the side surface which is formed with the inlet. The air channel is formed on the main body and communicates with the inlet. The air holes are formed on the reclining surface and communicate with the air channel. The deflector has a second connecting portion. The second connecting portion is connected to the first connecting portion. Thereby, the ventilative vehicle seat back of the present invention provides better ventilation so that a user doesn't feel hot and stuffy when reclining on the seat back.

### BACKGROUND OF THE INVENTION

1. Field of the Invention

The present invention relates to a vehicle seat back, and more specifically to a ventilative vehicle seat back.

2. Description of the Prior Art

To enhance the comfort of conventional vehicle seat backs, a vehicle seat back is developed to have a foam layer and a leather reclining surface. Said vehicle seat back is comfortable to be reclined, but it fails to cool the reclining surface when a user reclines on said vehicle seat back.

To solve the above-mentioned problem, vehicle seat backs as shown in TWM261396 and TWM373838 were brought into the market. Said vehicle seat backs can solve the heat problem occurred when a user's back touching a vehicle seat back, but said patents either require an additional power supply to drive a fan so as to generate an airflow, or need to be equipped with an extra wind pipe in a vehicle. Consequently, the hot or cool air can be lead into an air channel which is disposed on the vehicle seat backs. However, said patents have the following disadvantages:

1) It requires multiple devices such as fan, motor, and the like to generate airflow, so that the structure of said vehicle seat backs becomes more complicated.

2) Correspondingly, it needs to install additional devices to generate hot or cool air at the said seat backs. Therefore, users have to pay for the installation fee of the devices, or the fee may be transferred to the selling price of the vehicle. In this way, said vehicle seat backs are not competitive in price, and further fails to be affordable for all users.

3) An additional wind pipe, fan or other components connected to said seat backs will reduce the in-vehicle space and further have a bad effect on the design integrity of a vehicle.

4) Said patents rely on additional electric power to drive a fan. If an additional battery is used for power supply, it needs extra charge for battery and creates a recycling problem. If a vehicle battery is used for power supply, it may disturb the stability of the voltage for other devices of the vehicle.

The present invention is, therefore, arisen to obviate or at least mitigate the above mentioned disadvantages.

### SUMMARY OF THE INVENTION

The main object of the present invention is to provide a ventilative vehicle seat back without power driven systems.

Another object of the present invention is to provide a ventilative vehicle seat back which is environmentally friendly.

Another object of the present invention is to provide a ventilative vehicle seat back which has a simple structure without additional costs for installation.

To achieve the above and other objects, a ventilative vehicle seat back of the present invention includes a main body, at least one air channel, and a deflector. The main body has a reclining surface, two side surfaces, and a first connecting portion. Plural air holes are formed on the reclining surface. One of the side surfaces is formed with at least one inlet, and the inlet communicates with the air channel of the main body. The deflector has a second connecting portion. The second connecting portion is connected to the first connecting portion, so that the deflector can deflect the cool air, which is blown from a vehicle air conditioner, to the inlet of the side surface. Then, the cool air in the air channel is expelled from the air holes so as to cool down the heat accumulated when a user's back is touching the seat back. Similarly, the deflector can deflect the warm air, which is blown from the vehicle air conditioner, to the inlet of the side surface so as to warm up the user's back in the cold seasons.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram in accordance with a preferred embodiment of the present invention, wherein the deflector opens.

FIG. 2 is a stereogram in accordance with a preferred embodiment of the present invention, wherein the deflector closes and covers on the inlet.

FIG. 3 is a side sectional view in accordance with a preferred embodiment of the present invention.

FIG. 4 is a stereogram in accordance with another preferred embodiment of the present invention.

### DETAILED DESCRIPTION OF THE PREFERRED EMBODIMENTS

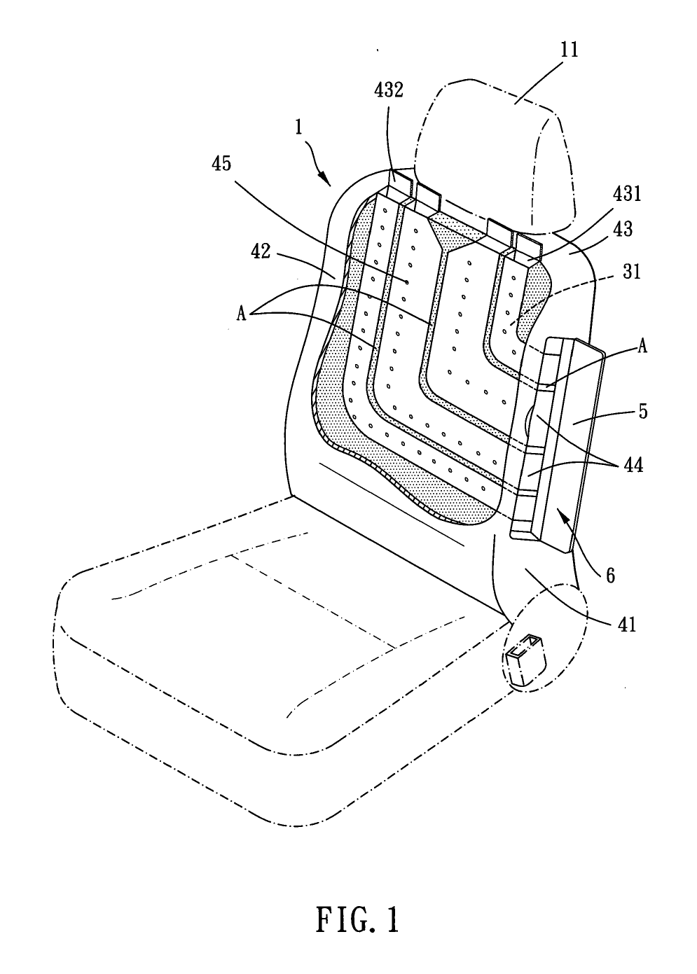

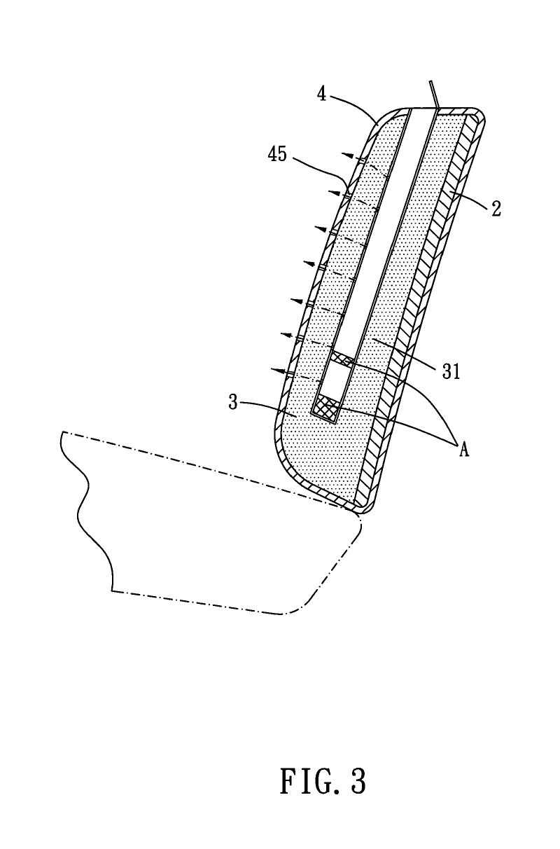

Please refer to FIG. 1 to FIG. 3 for a preferred embodiment of the present invention. A ventilative vehicle seat back of the embodiment includes a main body 1. The main body 1 has a support portion 2, a foam layer 3, a seat cover 4, and a deflector 5. The support portion 2 is coated with the foam layer 3, and the support portion 2 is formed with a first connecting portion. The seat cover 4 covers the foam layer 3. Said main body 1 further comprises two side surfaces 41, a reclining surface 42 and a top surface 43. The reclining surface 42 is provided for being reclined, and one of the side surfaces 41 which is away from a vehicle door is formed with at least one inlet 44. The first connecting portion of the support portion 2 is located at the side surface which is formed with the inlet 44.

Further, the foam layer 3 is formed with a flat room. Preferably, the flat room is divided into plural air channels 31 by plural L-shaped partitions A. The air channels 31 communicate with the inlet 44. In the present embodiment, the inlet 44 extends from one end of the air channels 31 so that the inlet 44 is formed in a shape like a flat groove. The shape can provide a good deflecting effect.

The top surface 43 of the main body can be disposed with a head portion 11 for a user's head to recline. The reclining surface 42 further comprises plural air holes 45 which communicate with the air channels. Preferably, the air holes 45 extend through the seat cover 4 and the foam layer 3 with a diameter of at least 1 millimeter. Thereby, air, which is blown from a vehicle air conditioner, flows through pores of the foam layer 3 or the air holes 45. The air is then expelled from the air holes of the reclining surface, and is blown toward a user's back which reclines on the reclining surface 42.

Moreover, the top surface 43 of the main body 1 is formed with one or more outlets 431. The outlet 431 communicates with another end of the air channels. Preferably, the main body 1 further comprises one or more lids 432. The quantity of the lids 432 is corresponding to the quantity of the outlets 431. The lid 432 can be detachably or pivotally fixed on one side of the outlet 431. Preferably, one end of the lid 432 is pivotally fixed near one side of the outlet 431, so that another end of the lid 432 can pivot and cover the outlet 431. When cool air contacts the user's back, warm air on the seat back will then be circulated and expelled through the outlet 431. Thereby, the cool air from the inlet 44 is exchanged with the warm air which is accumulated from the user's back. The warm air is then expelled from the outlet 431. The reclining surface 42 touched by the user's back for a long time can be cooled down by the circulation of the cool air. In the cold seasons, the lid 432 can be closed to cover on the outlet 431 so as to keep warm air in the air channels 31 and the air holes 45. In this way, the user's back can be kept warm.

The deflector 5 is a rectangle plate which is corresponding to the inlet 44. The deflector 5 has a second connecting portion. The second connecting portion is connected to the first connecting portion. The second connecting portion is an axle, and the first connecting portion is an axial hole for the axle to pivotally connect thereto. Thereby, the deflector 5 is disposed pivotally at one side of the inlet 44. Preferably, a deflecting slot 6 is defined between the deflector 5 and the side surface 41. The inlet 44 is located at one side of the deflecting slot 6 which is away from the reclining surface 42. Therefore, when air is blown from the air conditioner to backseats, the air is then lead to the inlet 44 by the deflector 6. The air then flows through the air channels 31 and comes out from the air holes 45. In this way, the cool air can be circulated inside of the vehicle seat back so as to avoid a hot and stuffy feeling when the user's back is reclining on the seat back.

In present embodiment, the deflector 5 is movable between a first position and a second position, so that the angle between the inlet 44 and the deflector 5 can be changed by demand. Thereby, the amount of cool air, which is lead into the inlet 44, can be adjusted. Preferably, the first connecting portion is connected pivotally to the second connecting portion, so that the second connecting portion is able to pivot with respect to the first connecting portion about an axle.

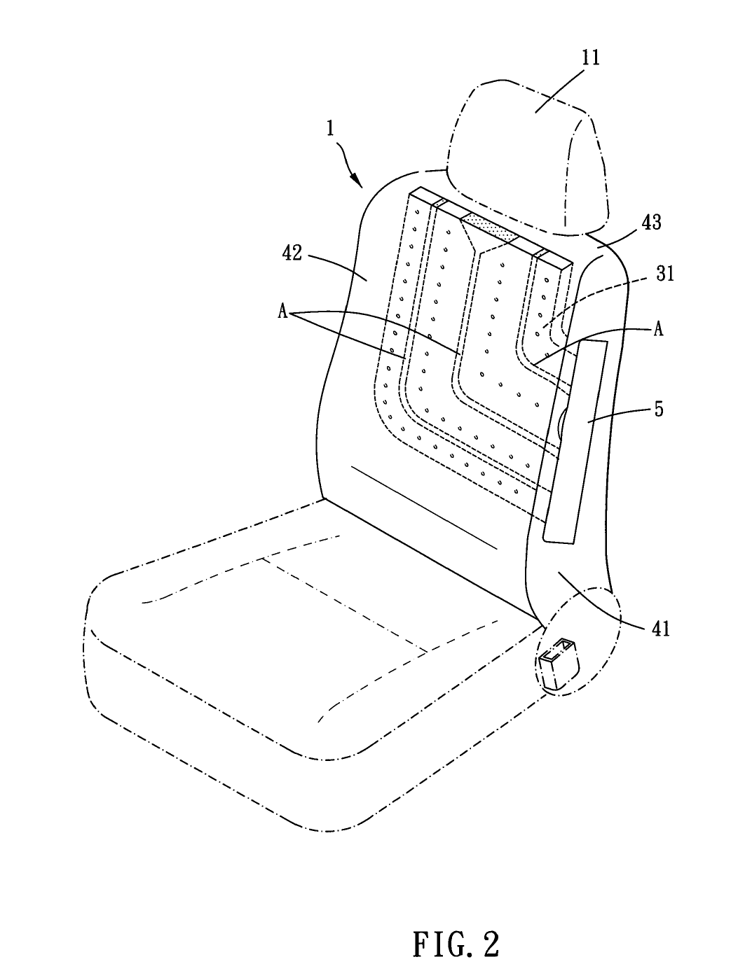

Please refer to the FIG. 1. When users feel hot and stuffy about their backs, the users can move the deflector 5 to the first position where the deflector 5 is disposed at an angle of 90° with the inlet 41 and has a better deflecting effect. By that means, the deflector 5 is disposed at a bigger angle with the inlet 41 so as to ventilate the vehicle seat back. When the user feels cold, the user can move the deflector 5 to the second position, as shown in FIG. 2, so that the deflector 5 closes the inlet 41 and prevents the air from flowing into the inlet 44. Consequently, the air conditioner has its original effect to moderate temperature.

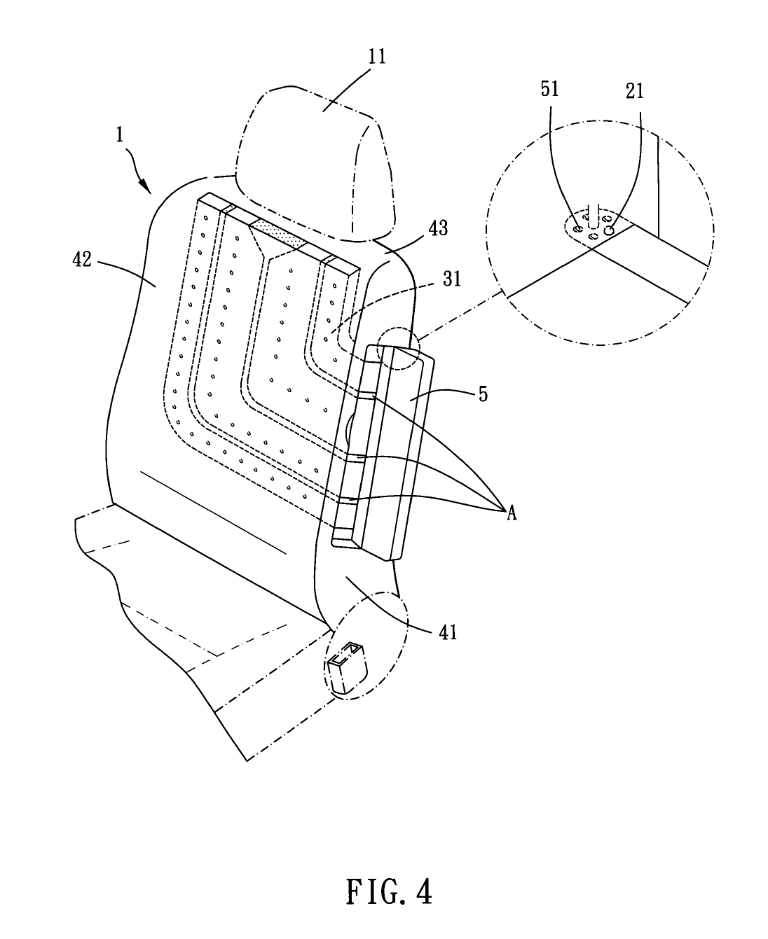

Please refer to the FIG. 4. In another embodiment, the first and the second connecting portion can be added with a position structure. One of the embodiments of the position structure is as disclosed as the FIG. 4. The first connecting portion is a bead 21, and the second connecting portion is a plurality of notches 51. The bead 21 can selectively abut against one of the notches 51. The bead moves from one of the notches 51 to another when the deflector 5 is pivoted. Accordingly, the users can change the angle between the deflector 5 and the inlet 41 by demand so as to accurately adjust the amount of the air which flows into the inlet 41. The position structure can be a ratchet formed on a connect area between the first and the second connecting portion, so that the deflector 5 can be located at multiple positions. In other possible embodiments, the first connecting portion can be a first fabric surface extending from the seat cover 4. The second connection portion can be a second fabric surface which covers the deflector 5. The connect area between the first and the second fabric surface is stitched up.

Accordingly, one of the side surfaces 41 of the vehicle seat back of the present invention is formed with at least one inlet 44. And a deflector which can pivot is disposed nearby the inlet 44. The present invention has the following advantages:

1) It has a temperature adjustment effect on the vehicle seat back without additional electric power. Therefore, there's no problem about the recycling of used battery and the voltage instability.

2) It includes a deflector, which is connected pivotally to the vehicle seat back, and a flat inlet, which is formed one a side surface of the vehicle seat back. In other words, it has a simple structure so that it doesn't require additional expense or costly installation fee.

3) The deflector 5 is used for blocking cool or warm air from a vehicle air conditioner and leading the air to circulate in the vehicle seat back. In other words, it recycles the air from the conditioner without consuming extra energy, so it is environmentally friendly.

4) Correspondingly, the deflector 5, which is disposed on the side surface of the seat back, can be closed and become a part of the seat back without occupying any in-vehicle space. And it doesn't have a bad effect on the design integrity of a vehicle.

From the above mentioned, it's obvious that the ventilative vehicle seat back of the present invention can overcome the disadvantages of the prior art with its simple structure.

1. A ventilative vehicle seat back, comprising:
a main body, having a reclining surface, two side surfaces, and a first connecting portion, the reclining surface adapted to be reclined, at least one inlet being formed on one of the side surfaces, the first connecting portion located on the side surface which is formed with the inlet; at least one air channel, formed in the main body, the air channel communicating with the inlet; plural air holes, formed on the reclining surface, the air holes communicating with the air channel;
a deflector, having a second connecting portion, and the second connecting portion connected to the first connecting portion.

2. The ventilative vehicle seat back of claim 1, wherein the deflector is movable between a first position and a second position so as to adjust an amount of air deflected into the inlet by the deflector.

3. The ventilative vehicle seat back of claim 2, wherein the first connecting portion is pivotally connected to the second connecting portion, so that the second connecting portion is able to pivot with respect to the first connecting portion about an axle.

4. The ventilative vehicle seat back of claim 3, wherein the first connecting portion comprises a bead, the second connecting portion comprises plural notches, and the bead selectively abuts against one of the notches.

5. The ventilative vehicle seat back of claim 1, wherein the main body comprises a top surface, the top surface is formed with at least one outlet, and the outlet communicates with the air channel.

6. The ventilative vehicle seat back of claim 5, wherein the main body further comprises at least one lid, one end of the lid is pivotally fixed on the main body, and the lid is located at one side of the outlet.

7. The ventilative vehicle seat back of claim 1, wherein the air channel is divided into plural L-shaped channels by plural partitions.
